(19) United States
(12) Patent Application Publication
(10) Pub. No.: US 2013/0037533 A1
(43) Pub. Date: Feb. 14, 2013

(54) ELECTRONIC DEVICE AND ELECTRONIC DEVICE CONTROL METHOD

(71) Applicants: Kimiyasu NAMEKAWA, Tokyo (JP); Akihiro EGAWA, Tokyo (JP)

(72) Inventors: Kimiyasu NAMEKAWA, Tokyo (JP); Akihiro EGAWA, Tokyo (JP)

(73) Assignee: Sony Corporation, Tokyo (JP)

(21) Appl. No.: 13/551,937

(22) Filed: Jul. 18, 2012

(30) Foreign Application Priority Data
Aug. 12, 2011 (JP) 2011-177053

(51) Int. Cl. G01K 3/00; H05B 1/02

(52) U.S. Cl. 219/494; 374/102; 374/E03.001

(57) ABSTRACT

Provided is an electronic device including a temperature measuring part measuring a temperature of a heat generation source generating heat caused by power consumption or of a portion inside a housing that varies in temperature due to heat generation of the heat generation source; and an ambient temperature calculating part calculating a temperature by use of a predetermined relational formula that differs according to a model based on a difference between a first temperature measured by the temperature measuring part after the elapse of a first predetermined period of time from the start of constant power consumption by the heat generation source and a second temperature measured by the temperature measuring part further after the elapse of a second predetermined period of time as an ambient temperature of an environment in which the housing is placed.

### BACKGROUND

The present disclosure relates to an electronic device and an electronic device control method, and particularly to a portable electronic device such as a digital camera, a mobile telephone and a portable audio player, and a control method of the electronic device.

The main theme of a portable device such as a digital video camera, a digital still camera, a mobile telephone, a portable audio player and others is to achieve both high functionality and downsizing in accordance with public demand. Further, as downsizing is promoted, functions originally provided in separate devices are incorporated in one device is commercialized. In an example of such device, functions of a digital still camera, a portable audio player and a mobile telephone are incorporated in one device.

However, high functionality of an electronic device indicates increase in throughput of an embedded IC, which naturally results in increase in an amount of heat generation of the IC. When a device heats up to over its performance assurance temperature, a variety of problems arise. When an image sensor such as CCD (Charge Coupled Device) image sensor or CMOS (Complementary Metal Oxide Semiconductor) image sensor heats up to a high temperature, for example, a problem of noise increase or the like arises.

Accordingly, various improvements are made because it is necessary to effectively dissipate heat generated by IC. For example, a heat dissipation structure is disclosed which can reduce a temperature rise inside a digital camera by efficiently dissipating heat generated inside the digital camera to the outside (Japanese Patent Laid-Open No. 2008-271571).

### SUMMARY

In order to dissipate heat generated by a heat generation source inside a portable electronic device, a structure for transferring the generated heat to a housing of the electronic device can be applicable. But when a temperature of the housing rises too high, a user suffers from a feeling of discomfort or low temperature burns. Accordingly, it is preferable to take measures such as to stop an operation of the electronic device when a temperature of the heat generation source inside the electronic device rises to a certain degree.

However, the feeling of discomfort of the user is not caused by an absolute temperature of the housing but rather caused largely by a relative temperature of the housing with respect to a temperature of usage environment of the electronic device. But, there has been a problem that cost of the electronic device increases when the electronic device is provided with means for directly measuring the temperature of the usage environment of the electronic device.

According to an embodiment of the present disclosure, there is provided a novel and improved electronic device and an electronic device control method which can accurately calculate an ambient temperature by measuring a temperature of a portion where a temperature varies due to heat generation of the heat generation source.

According to an embodiment of the present disclosure, there is provided an electronic device which includes a temperature measuring part measuring a temperature of a heat generation source generating heat caused by power consumption or of a portion inside a housing that varies in temperature due to heat generation of the heat generation source, and an ambient temperature calculating part calculating a temperature by use of a predetermined relational formula that differs according to a model based on a difference between a first temperature measured by the temperature measuring part after the elapse of a first predetermined period of time from the start of constant power consumption by the heat generation source and a second temperature measured by the temperature measuring part further after the elapse of a second predetermined period of time from the time point after the elapse of the first predetermined period of time from the start of the constant amount of power consumption by the heat generation source as an ambient temperature of an environment in which the housing is placed.

According to another embodiment of the present disclosure, there is provided an electronic device control method which includes measuring a first temperature of a heat generation source generating heat caused by power consumption or of a portion inside a housing that varies in temperature due to heat generation of the heat generation source after the elapse of a first predetermined period of time from the start of constant power consumption by the heat generation source, measuring a second temperature of the heat generation source or of the portion inside the housing further after the elapse of a second predetermined period of time from the time point after the elapse of the first predetermined period of time from the start of the constant amount of power consumption by the heat generation source, and calculating a temperature by use of a predetermined relational formula that differs according to a model based on a difference between the first temperature and the second temperature as an ambient temperature of an environment in which the housing is placed.

According to the embodiment of the present disclosure described above, a novel and improved electronic device and an electronic device control method which can accurately calculate an ambient temperature by measuring a portion where a temperature varies due to heat generation of the heat generation source can be provided.

### BRIEF DESCRIPTION OF THE DRAWINGS

FIG. 1 is a perspective view, when viewed from front, explanatory of an appearance of an imaging device 100 according to an embodiment of the present disclosure;

FIG. 2 is a perspective view, when viewed from back, explanatory of the appearance of the imaging device 100 according to the embodiment of the present disclosure;

FIG. 3 is a diagram explanatory of a functional configuration of the imaging device 100 according to the embodiment of the present disclosure;

FIG. 4 is a diagram explanatory of a heat dissipation structure of the imaging device 100 according to the embodiment of the present disclosure;

FIG. 5 is a graph explanatory of a relationship between a temperature rise of a CMOS image sensor 124 and a temperature rise of a housing 110;

FIG. 6 is a graph explanatory of a relationship between elapsed time from the start of video shooting by the imaging device 100 and variation in temperature difference of the CMOS image sensor 124 from an ambient temperature;

FIG. 7 is a graph explanatory of a relationship between variation in temperature difference of the CMOS image sensor 124 and the temperature difference of the CMOS image sensor 124 from an ambient temperature;

FIG. 8 is a flowchart illustrating a calculating method of the ambient temperature performed by use of the imaging device 100 according to a present embodiment;

FIG. 9 is a flowchart illustrating monitoring processing of the temperature of the CMOS image sensor 124 according to an embodiment of the present disclosure;

FIG. 10 is a diagram explanatory of an example of a temperature indicator displayed on a display part 118;

FIG. 11 is a diagram explanatory of a configuration example of a computer 900 achieving a series of processing by performing a program;

FIG. 12 is a graph explanatory of a relationship between variation in temperature difference of the CMOS image sensor 124 and the temperature difference of the CMOS image sensor 124 from the ambient temperature;

FIG. 13 is a graph explanatory of a relationship between variation in temperature difference of the CMOS image sensor 124 and the temperature difference of the CMOS image sensor 124 from the ambient temperature; and

FIG. 14 is a flowchart illustrating a calculating method of the ambient temperature performed by use of the imaging device 100 according to the present embodiment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The embodiment will be described in the following order.

### <1. Embodiments of Present Disclosure>

### [1-1. Imaging Device Appearance Example]

### [1-2. Imaging Device Functional Configuration]

### [1-3. Imaging Device Heat Dissipation Structure]

### [1-4. Ambient Temperature Calculating Method]

### [1-5. CMOS Image Sensor Temperature Monitoring Processing]

### <2. Conclusion>

### 1. EMBODIMENTS OF PRESENT DISCLOSURE

### 1-1. Imaging Device Appearance Example

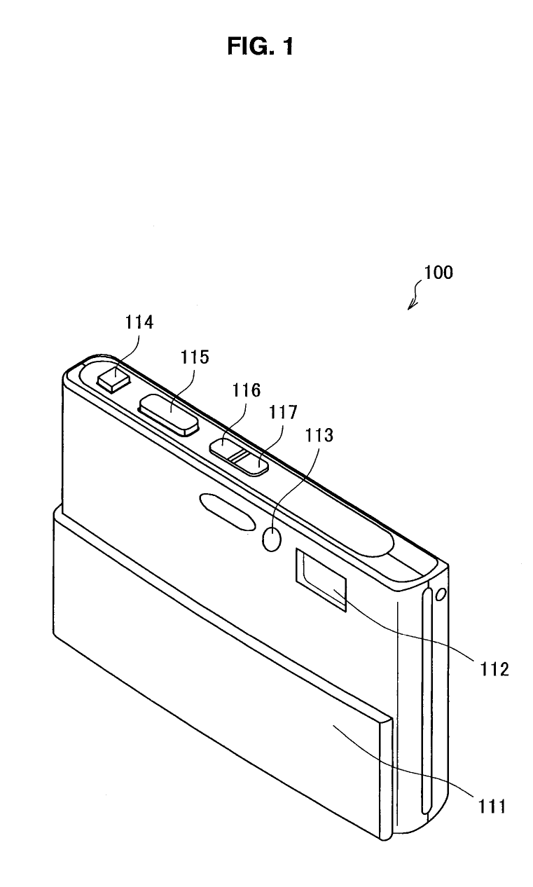

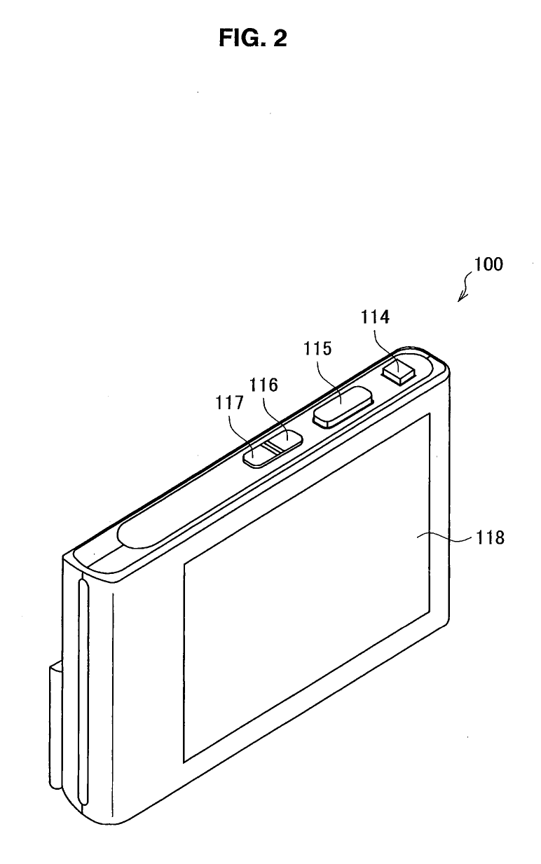

First, an appearance example of an imaging device as an example of an electronic device of the present disclosure will be described with reference to the drawings. FIG. 1 is a perspective view, when viewed from front, of an imaging device 100 according to the embodiment of the present disclosure explanatory of an appearance of the imaging device 100. FIG. 2 is a perspective view, when viewed from back, of the imaging device 100 according to the embodiment of the present disclosure explanatory of the appearance of the imaging device 100.

The imaging device 100 according to the embodiment of the present disclosure illustrated in FIG. 1 and FIG. 2 includes a housing 110 for housing circuits, components and the like inside and a sliding lens cover 111 covering the housing 110. The housing 110 and the lens cover 111 are arranged such that when the lens cover 111 is slid downward to be opened, imaging lenses 112 and an AF illuminator 113 appear. The AF illuminator 113 doubles as a self-timer lamp. Further, on a back face of the imaging device 100, a display part 118 including an LCD panel, an organic EL panel or the like is provided so as to occupy most part of the back face.

Still further, a zoom lever (TELE/WIDE) 114 for changing shooting magnification when taking images, a shutter button 115 for a start of shooting still images or moving images, a play button 116 for displaying shot data stored inside the imaging device 100 on the display part 118 and a power button 117 for powering on or powering off the imaging device 100 are arranged on a top face of the imaging device 100.

In the imaging device 100 according to the embodiment of the present disclosure, light condensed by the imaging lenses 112 is irradiated on an image sensor such as a CCD image sensor or a CMOS image sensor and converted by the image sensor to electrical signals thereby to obtain imaging data. The imaging device 100 according to the embodiment of the present disclosure has a structure of transferring heat of the image sensor generated during an imaging operation to the housing 110. A heat dissipation structure of the image sensor will be described later.

In the above description, the appearance of the imaging device 100 according to the embodiment of the present disclosure is described. Next, a functional configuration of the imaging device 100 according to the embodiment of the present disclosure will be described.

### 1-2. Imaging Device Functional Configuration

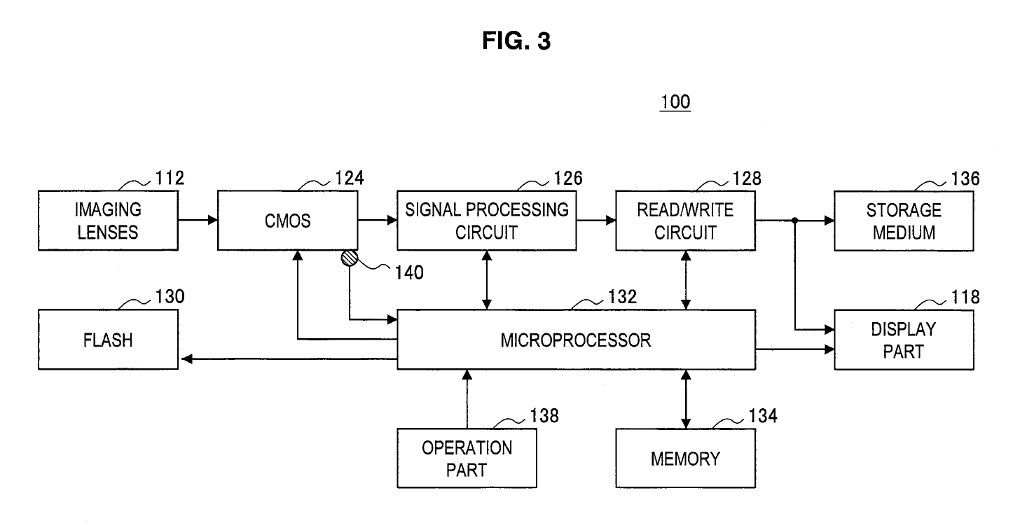

FIG. 3 is a diagram explanatory of a functional configuration of the imaging device 100 according to the embodiment of the present disclosure. The functional configuration of the imaging device 100 according to the embodiment of the present disclosure will be described below.

The imaging device 100 according to the embodiment of the present disclosure includes, as illustrated in FIG. 3, the imaging lenses 112, the display part 118, a CMOS image sensor 124, a signal processing circuit 126, a read/write circuit 128, a flash 130, a microprocessor 132, a memory 134, a storage medium 136, an operation part 138 and a temperature measuring part 140.

The imaging lenses 112 condense and introduce, when taking an image by use of the imaging device 100, light from an object into the imaging device 100. The light condensed by the imaging lenses 112 is transferred to the CMOS image sensor 124.

The CMOS image sensor 124 converts the light condensed by the imaging lenses 112 to full-color image data (RAW data). The RAW data created by the CMOS image sensor 124 is transmitted to the signal processing circuit 126. Note that, a CCD image sensor may be applied instead of the CMOS image sensor 124 in the present disclosure.

The signal processing circuit 126 performs signal processing on the RAW data created by the CMOS image sensor 124 and creates image data. The signal processing performed by the signal processing circuit 126 includes demosaicing, noise rejection, compression or the like. The image data created as a result of the signal processing performed by the signal processing circuit 126 is stored in the storage medium 136 or displayed on the display part 118 under the control of the read/write circuit 128.

The read/write circuit 128 controls writing of the image data into the storage medium 136 or reading of the image data from the storage medium 136, and display of the image data on the display part 118.

The flash 130 emits light for exposing an object to light when an image is shot by the imaging device 100. The microprocessor 132 controls each part of the imaging device 100. In the present embodiment, the microprocessor 132 calculates a temperature of the housing 110 based on a temperature measured by the temperature measuring part 140 described below and controls an operation of the imaging device 100 based on the calculated temperature of the housing 110 and the temperature measured by the temperature measuring part 140 described below. That is, the microprocessor 132 has functions as an ambient temperature calculating part and an operation control part of the present disclosure. The memory 134 stores information used for the operation of the imaging device 100. The memory 134 may store information of various settings, time and the like at the time of shooting. A volatile memory may be used or a nonvolatile memory in which information is not cleared even when the imaging device 100 is powered off may be used as the memory 134.

The storage medium 136 stores images shot by the imaging device 100. The images are stored in the storage medium 136 by control of the read/write circuit 128. The images stored in the storage medium 136 can be displayed on the display part 118 by control of the read/write circuit 128.

The operation part 138 acknowledges operations on the imaging device 100. In the imaging device 100 according to the present embodiment, the operation part 138 includes the zoom lever 114, the shutter button 115 for a start of shooting still images or moving images, the play button 116 for displaying shot data stored inside the imaging device 100 on the display part 118 and the power button 117 for powering on or powering off the imaging device 100.

The display part 118 includes the LCD panel, the organic EL panel or the like as described above, and displays images shot by the imaging device 100 or displays a screen for various settings for the imaging device 100. Display of the images on the display part 118 is controlled by the microprocessor 132.

The temperature measuring part 140 measures a temperature of the CMOS image sensor 124. As the temperature measuring part 140, a sensor that can measure a temperature such as a thermistor can be applied. The temperature of the CMOS image sensor 124 measured by the temperature measuring part 140 is transmitted to the microprocessor 132. The microprocessor 132 calculates an ambient temperature of an environment in which the imaging device 100 is placed based on the temperature of the CMOS image sensor 124 measured by the temperature measuring part 140. Accordingly, the microprocessor 132 functions as an ambient temperature calculating part of the present disclosure as described above.

In the above description, the functional configuration of the imaging device 100 according to the embodiment of the present disclosure is described with reference to FIG. 3. Next, the heat dissipation structure of the imaging device 100 according to the embodiment of the present disclosure will be described.

### 1-3. Imaging Device Heat Dissipation Structure

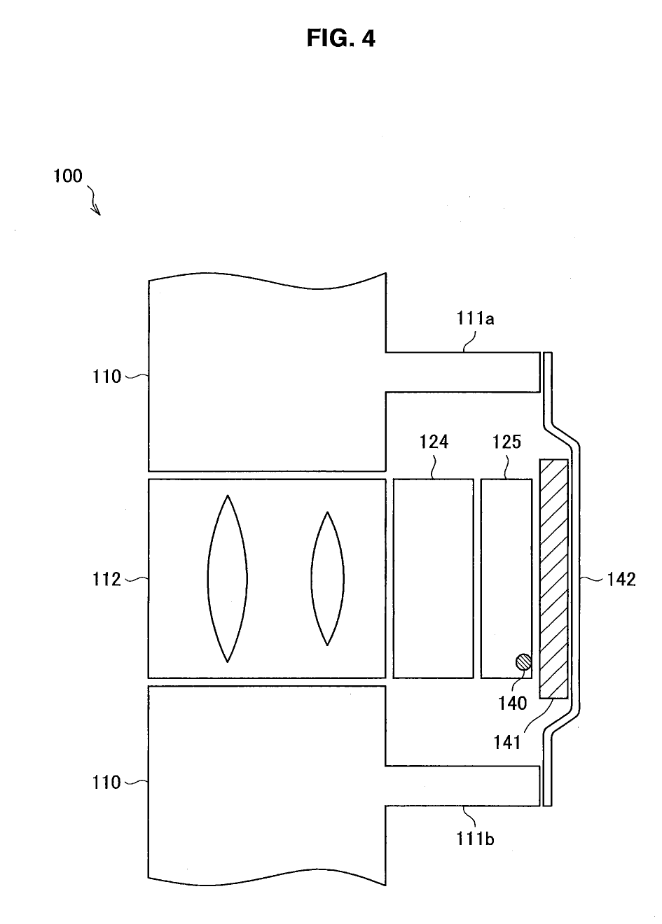

FIG. 4 is a diagram explanatory of the heat dissipation structure of the imaging device 100 according to the embodiment of the present disclosure. The heat dissipation structure of the imaging device 100 according to the embodiment of the present disclosure will be described below in detail with reference to FIG. 4.

In the imaging device 100 according to the present embodiment, the temperature measuring part 140 is placed on a drive substrate 125 for driving the CMOS image sensor 124, and the temperature measuring part 140 measures a temperature of the CMOS image sensor 124. The imaging device 100 according to the embodiment of the present disclosure has a structure for transferring heat generated by the CMOS image sensor 124 due to consumption of power by the CMOS image sensor 124 to the housing 110.

As illustrated in FIG. 4, the imaging device 100 according to the embodiment of the present disclosure includes, for transferring heat generated by the CMOS image sensor 124 to the housing 110, a cooling sheet 141 placed on a back face of the drive substrate 125 and a heat sink 142 placed in contact with the cooling sheet 141 and in contact with the housing 110 at protrusions 111a, 111b.

Heat dissipation of the CMOS image sensor 124 will be described with reference to FIG. 4. When the CMOS image sensor 124 is continuously driven in such a case of long periods of video shooting on the display part 118, the CMOS image sensor 124 generates heat. Heat generated by the CMOS image sensor 124 is transferred from the drive substrate 125 to the cooling sheet 141 and the heat sink 142, and transferred from the heat sink 142 to the housing 110 via the protrusions 111a, 111b.

It is preferable to use a material having high thermal conductivity for the heat sink 142. The material having high thermal conductivity includes a plate made of metal, a sheet made of metal, a flexible substrate, a graphite sheet and the like. Similarly, it is preferable to use the material having high thermal conductivity for the housing 110 for dissipating heat generated by the CMOS image sensor 124.

Providing such heat dissipation structure in the imaging device 100 reduces a temperature rise of the CMOS image sensor 124 when the CMOS image sensor 124 is continuously driven in such a case of long periods of video shooting on the display part 118 and reduces noise generation on imaging data.

Further, in the imaging device 100 according to the embodiment of the present disclosure, the temperature measuring part 140 is placed on the drive substrate 125, and the absolute temperature of the CMOS image sensor 124 can be obtained by using the temperature measuring part 140 placed on the drive substrate 125. The temperature rise can be inhibited by issuing an alert by the microprocessor 132 or suspending functions as the imaging device when the absolute temperature of the CMOS image sensor 124 exceeds a predetermined temperature.

By providing the heat dissipation structure transferring heat of the CMOS image sensor 124 to the housing 110 as illustrated in FIG. 4, it is necessary to pay attention to not only the absolute temperature of the CMOS image sensor 124 but also to a rise of an absolute temperature of the housing 110 because a user of the imaging device 100 is likely to feel heat when holding the housing 110 or suffer from burns (low temperature burns). However, the reason why the user of the imaging device 100 feels uncomfortable stems not from the absolute temperature of the housing 110 but rather largely from a relative temperature of the housing 110 with respect to usage environment of the imaging device 100 as described above. Accordingly, though it is the best way to measure the temperature of the usage environment of the imaging device 100, it is extremely difficult for providing measuring means for the temperature of the usage environment of the imaging device 100 other than the measuring means for the absolute temperature of the CMOS image sensor 124 because of cost increase.

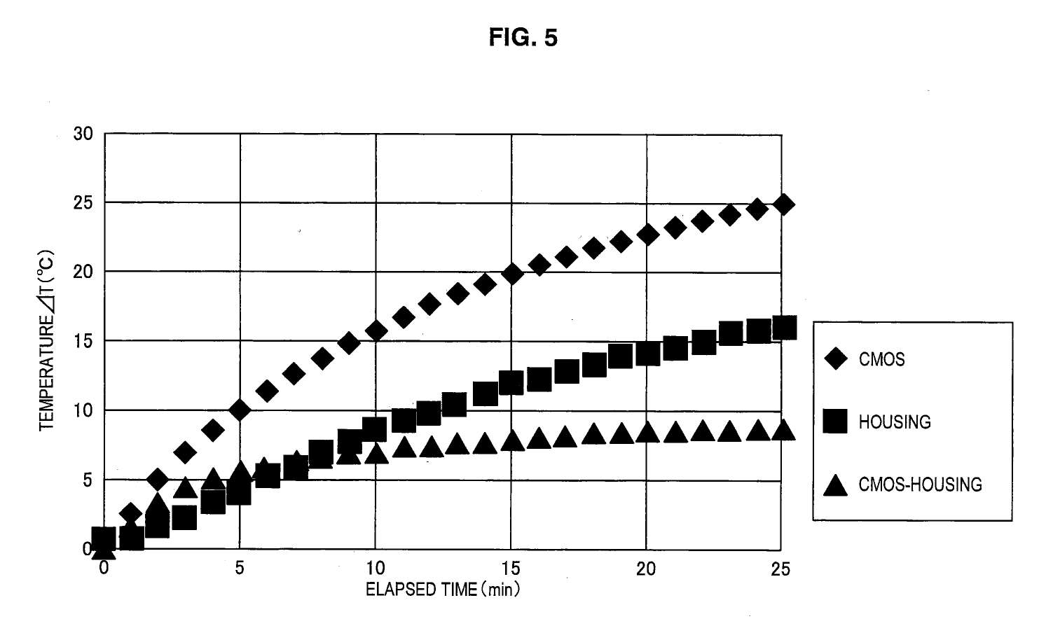

By providing the heat dissipation structure of the CMOS image sensor 124 as illustrated in FIG. 4, a temperature rise of the CMOS image sensor 124 and a temperature rise of the housing 110 show a predetermined relationship with each other. FIG. 5 is a graph explanatory of the relationship between the temperature rise of the CMOS image sensor 124 and the temperature rise of the housing 110. As illustrated in FIG. 5, the temperature of the housing 110 rises as the temperature of the CMOS image sensor 124 rises.

Accordingly, in the imaging device 100 according to the embodiment of the present disclosure, the temperature (ambient temperature) of the environment around the housing 110 is calculated based on variation of the absolute temperature of the CMOS image sensor 124 measured by the temperature measuring part 140. By calculating the ambient temperature as described above, the microprocessor 132 can issue an alert or suspend functions as the imaging device when a difference between the calculated ambient temperature and the absolute temperature of the CMOS image sensor 124 measured by the temperature measuring part 140 exceeds a predetermined value.

A calculating method of the ambient temperature based on variation of the absolute temperature of the CMOS image sensor 124 measured by the temperature measuring part 140 will be described below.

### 1-4. Ambient Temperature Calculating Method

In the case where an amount of heat generation from the CMOS image sensor 124 that is the heat generation source is constant, the temperature of the housing 110 varies independent of the absolute value of the ambient temperature but depending on a temperature difference between the ambient temperature and the temperature of the housing 110. The case where the amount of heat generation from the CMOS image sensor 124 that is the heat generation source is constant corresponds to the case of video shooting by using the CMOS image sensor 124, for example.

Based on this knowledge, a relationship between (1) a temperature difference between the ambient temperature and the temperature of the housing 110 and (2) a temperature rise of the housing over time is preliminarily measured, and the measured result is stored in the memory 134 in the present embodiment. The relationship between (1) a temperature difference between the ambient temperature and the temperature of the housing 110 and (2) a temperature rise of the housing over time can be approximated by a linear relationship as described below, so that the ambient temperature can be calculated from temperature change of the CMOS image sensor 124, that is, temperature change of the housing 110.

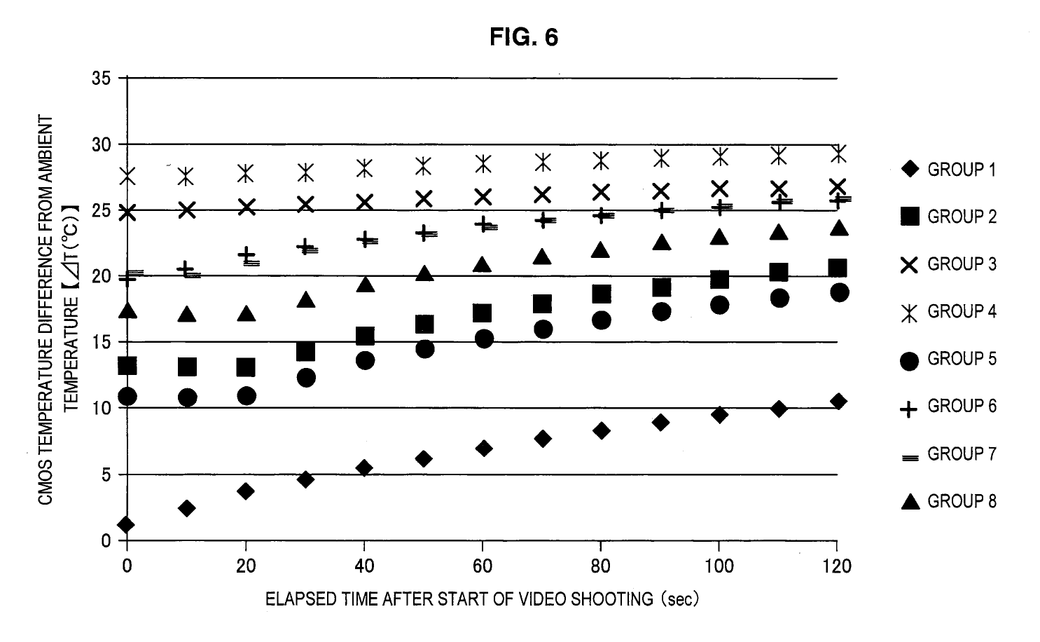

FIG. 6 is a graph explanatory of a relationship between elapsed time from the start of video shooting by the imaging device 100 and variation in temperature difference of the CMOS image sensor 124 from the ambient temperature. On the graph illustrated in FIG. 6, processes of the temperature rise are plotted by changing conditions of the temperature difference of the CMOS image sensor 124 from the ambient temperature at the start of video shooting by the imaging device 100. FIG. 6 indicates that the temperature difference of the CMOS image sensor 124 from the ambient temperature after 2 minutes (after 120 seconds) varies approximately 10.5 degree in the case where the temperature difference of the CMOS image sensor 124 from the ambient temperature is nearly zero at the start of video shooting by the imaging device 100. Further, the temperature rise of the CMOS image sensor 124 during 2 minutes is small in the case where the temperature difference of the CMOS image sensor 124 from the ambient temperature is 25 degrees and over at the start of video shooting by the imaging device 100.

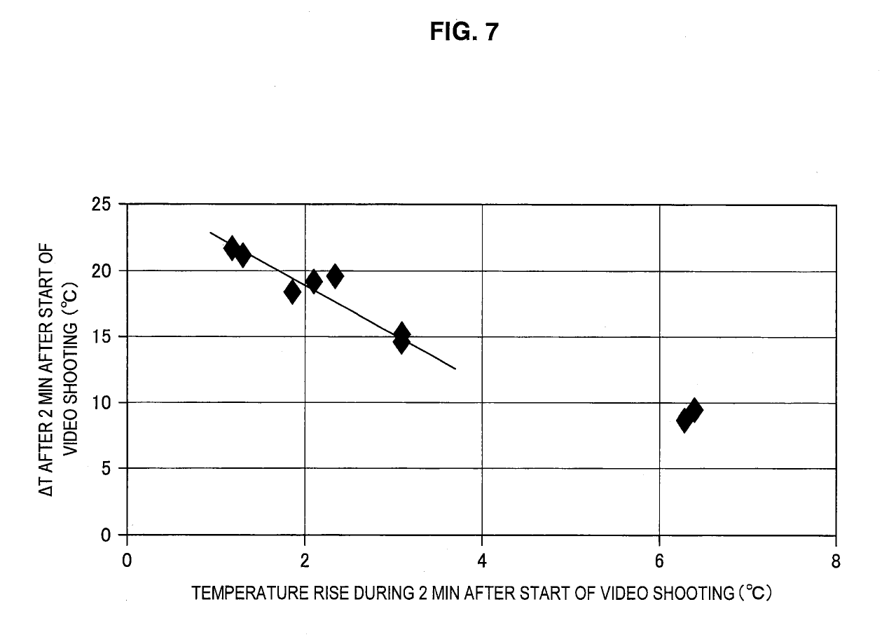

The variation in temperature difference of the CMOS image sensor 124 after 2 minutes from the start of video shooting by the imaging device 100 and the temperature difference of the CMOS image sensor 124 from the ambient temperature after 2 minutes from the start of video shooting by the imaging device 100 can be approximated linear relationships, respectively. FIG. 7 is a graph explanatory of a relationship between the variation in temperature difference of the CMOS image sensor 124 during 2 minutes after the start of video shooting by the imaging device 100 and the temperature difference of the CMOS image sensor 124 from an ambient temperature after 2 minutes from the start of video shooting by the imaging device 100. In the graph of FIG. 7, the horizontal axis represents the amount of variation in temperature difference of the CMOS image sensor 124 from the ambient temperature during 2 minutes after the start of video shooting by the imaging device 100, and the vertical axis represents the temperature difference of the CMOS image sensor 124 from the ambient temperature after 2 minutes from the start of video shooting by the imaging device 100. In the graph of FIG. 7, a degree of the temperature rise in each group illustrated in FIG. 6 is plotted by each mark.

As can be appreciated from FIG. 7, a relationship between the degree of the temperature rise of the CMOS image sensor 124 and the temperature difference of the CMOS image sensor 124 from the ambient temperature after 2 minutes from the start of video shooting by the imaging device 100 can be approximated by a predetermined linear function.

In approximating, because a point indicating a temperature rise x of an extremely small amount or an extremely large amount deviates from the predetermined linear function as approximated above, it is preferable to eliminate the point indicating the temperature rise x of an extremely small amount or an extremely large amount. The point indicating the temperature rise x of an extremely small amount represents a state where an amount of heat generation and a heat dissipation amount of the imaging device 100 are saturated and because such state scarcely occurs in practice in the imaging device 100 which controls power consumption depending on a temperature, there is no problem of the point deviating from an approximation straight line. Further, the point indicating the temperature rise x of an extremely large amount represents a state where video shooting starts from a state of the imaging device 100 not being used for a long time and because the ambient temperature can be precisely calculated by other means described below, there is no problem of the point deviating from the approximation straight line.

Accordingly, the temperature difference of the CMOS image sensor 124 from the ambient temperature after two minutes from the start of video shooting by the imaging device 100 is calculated by preliminarily storing information of the approximated linear function in the memory 134, calculating the temperature of the CMOS image sensor 124 at the time of starting video shooting by the imaging device 100 and the temperature difference of the CMOS image sensor 124 from the ambient temperature after two minutes from the start of video shooting, and substituting the calculation results in the approximated linear function. The estimated ambient temperature around the imaging device 100 can be calculated by subtracting the temperature difference calculated as above from the temperature of the CMOS image sensor 124 after 2 minutes from the start of video shooting.

In the example illustrated in FIG. 7, the relationship between the temperature rise x of the CMOS image sensor 124 and the temperature difference y of the CMOS image sensor 124 from the ambient temperature after 2 minutes from the start of video shooting by the imaging device 100 can be approximated by the following formula:

y=−3.34x+25.55 (Formula 1)

Accordingly, the temperature difference of the CMOS image sensor 124 from the ambient temperature after 2 minutes from the start of video shooting by the imaging device 100 can be calculated by substituting temperature rise degree of the CMOS image sensor 124 during 2 minutes in the above formula 1.

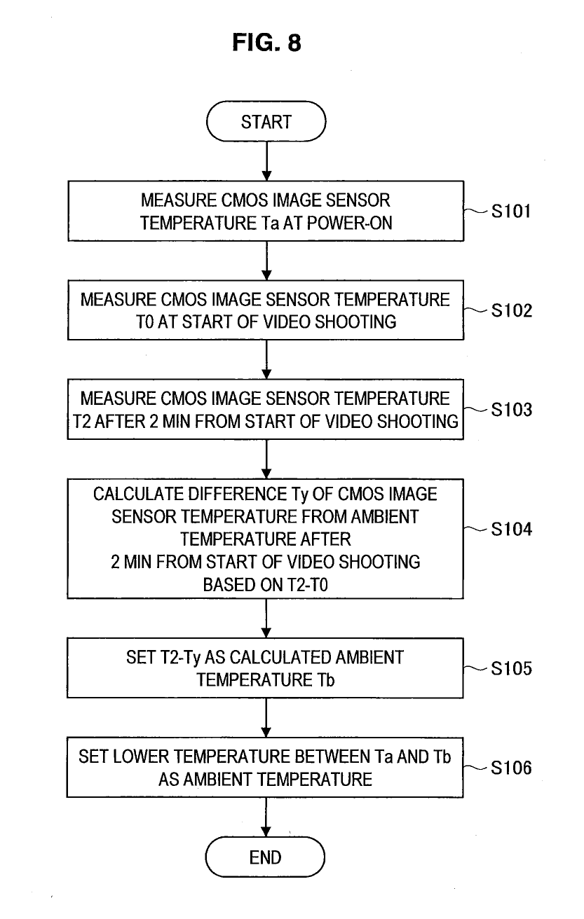

A calculating method of the ambient temperature by use of the imaging device 100 according to the present embodiment will be described in detail. FIG. 8 is a flowchart illustrating the calculating method of the ambient temperature performed by use of the imaging device 100 according to the present embodiment. The calculating method of the ambient temperature by use of the imaging device 100 according to the present embodiment will be described with reference to FIG. 8.

At first, the microprocessor 132 acquires a temperature Ta of the CMOS image sensor 124 by use of the temperature measuring part 140 when the imaging device 100 is powered on (step S101). The microprocessor 132 holds the information of the acquired temperature Ta in the memory 134, for example. The temperature Ta can be considered as the ambient temperature around the imaging device 100 when the imaging device 100 is not used for a long time, for example, and the temperature Ta is appropriate for use as a temporary ambient temperature.

When the temperature measuring part 140 acquires the temperature Ta of the CMOS image sensor 124 when the imaging device 100 is powered on, and thereafter, the microprocessor 132 waits until video shooting processing is started by a user of the imaging device 100. When the video shooting processing is started by the user of the imaging device 100, the microprocessor 132 acquires a temperature T0 of the CMOS image sensor 124 at the start of video shooting processing by use of the temperature measuring part 140 (step S102).

Subsequently, the microprocessor 132 acquires a temperature T2 of the CMOS image sensor 124 by use of the temperature measuring part 140 after 2 minutes from the start of video shooting processing (step S103). Note that, when the video shooting processing by use of the imaging device 100 is completed in less than 2 minutes, the microprocessor 132 does not measure the temperature T2.

Note that, though the ambient temperature is measured by acquiring the temperature T2 of the CMOS image sensor 124 after 2 minutes from the start of video shooting processing in the present embodiment by use of the temperature measuring part 140, the present disclosure is not limited to this calculating method of the ambient temperature.

After completion of acquiring the temperatures T0 and T2, subsequently, the microprocessor 132 calculates T2-T0, and calculates the temperature difference Ty of the CMOS image sensor 124 from the ambient temperature after 2 minutes from the start of video shooting by substituting the calculated value into the linear function preliminarily stored in the memory 134 (step S104).

When the temperature difference Ty of the CMOS image sensor 124 from the ambient temperature after 2 minutes from the start of video shooting is calculated, subsequently, the microprocessor 132 sets a value obtained by an operation of subtraction of the temperature difference Ty from the temperature T2 as a calculated ambient temperature Tb (step S105).

For example, assuming that the temperature T0 of the CMOS image sensor 124 at the start of video shooting processing is 38.4[° C.], and the temperature T2 of the CMOS image sensor 124 after 2 minutes from the start of video shooting processing is 41.5[° C.]. Since T2−T0=3.1[° C.], when 3.1 is substituted in x of the above-described formula 1, a value of y results in y=15.2. Accordingly, the temperature difference Ty of the CMOS image sensor 124 from the ambient temperature after 2 minutes from the start of video shooting in this case results in Ty=15.2[° C.]. And the calculated ambient temperature Tb is calculated as T2−Ty=41.5−15.2=26.3[° C.].

At the end, the microprocessor 132 stores in the memory 134 a lower temperature selected between the temperature Ta of the CMOS image sensor 124 acquired in the above-described step S101 when the imaging device 100 is powered on and the calculated ambient temperature Tb calculated in the above-described step S105 (step S106). For example, assuming that the temperature Ta is 27.0[° C.] and the temperature Tb is 26.3[° C.], the microprocessor 132 stores the temperature Tb in the memory 134 as the ambient temperature around the imaging device 100. Then, the microprocessor 132 performs monitoring processing of the temperature of the CMOS image sensor 124 by use of the ambient temperature stored in the memory 134.

In the above description, the calculating method of the ambient temperature by use of the imaging device 100 according to the present embodiment is described with reference to FIG. 8. As described above, the present disclosure is not limited to the example of this calculating method of the ambient temperature. Subsequently, another example of the calculating method of the ambient temperature by use of the imaging device 100 according to the present embodiment will be described.

For example, the ambient temperature may be calculated by setting T2 to a temperature value after any period of time such as 1 minute, 3 minutes or 5 minutes from the start of video shooting processing by the imaging device 100. Alternatively, in order to more accurately calculate the ambient temperature, the ambient temperature may be calculated based on a temperature T1 of the CMOS image sensor 124 after a certain period of time from the start of video shooting processing by the imaging device 100 and a temperature T3 of the CMOS image sensor 124 further after any period of time such as 1 minute, 2 minutes or 3 minutes from the time after a certain period of time from the start of video shooting processing.

The reason why the temperature T1 of the CMOS image sensor 124 after a certain period of time from the start of video shooting processing by the imaging device 100 is used for calculation of the ambient temperature is that there is variation in amount of heat stored in members incorporated inside the imaging device 100 immediately after the start of video shooting processing as will be described below. The above-described certain period of time may be determined in consideration of condition of a heat dissipation route through which heat from the CMOS image sensor 124 is transferred to the housing 110.

For example, the above-described certain period of time may be determined in consideration of time until heat capacity of the heat dissipation route through which heat from the CMOS image sensor 124 is transferred to the housing 110 is saturated. The above-described certain period of time may be determined in consideration of a period of time until heat stored, before the CMOS image sensor 124 starts to consume constant electricity, in the heat dissipation route through which heat from the CMOS image sensor 124 is transferred to the housing 110 does not exert influence on calculation of the ambient temperature. Or the above-described certain period of time may be determined in consideration of time necessary until heat conduction in the heat dissipation route transferring heat from the CMOS image sensor 124 to the housing 110 and heat conduction from the heat dissipation route to the housing 110 become uniform.

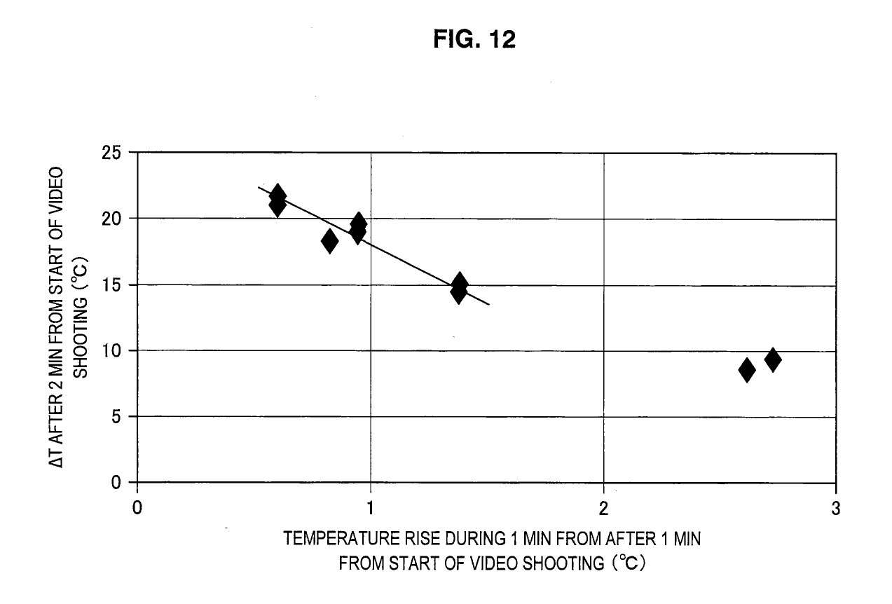

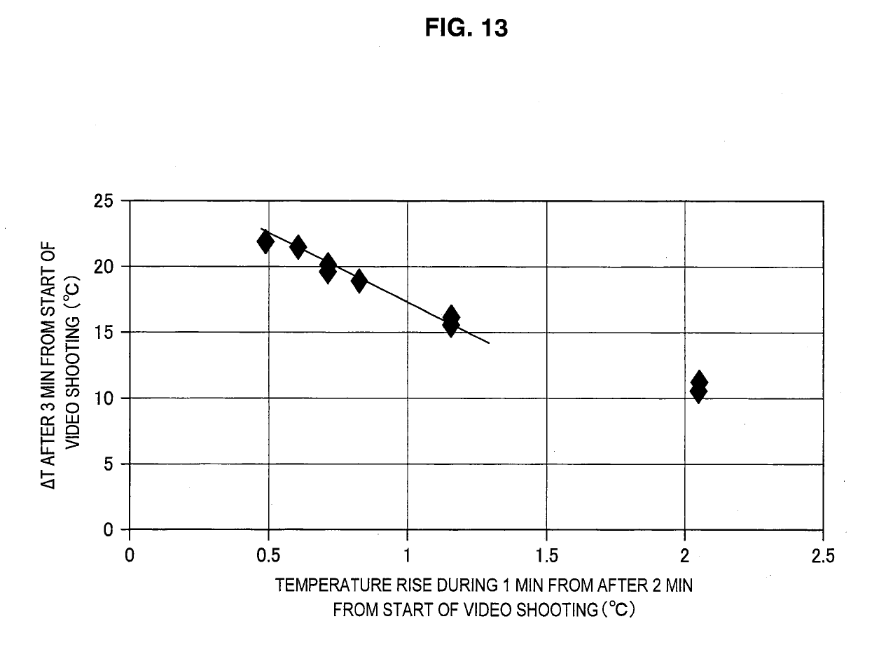

FIG. 12 and FIG. 13 are graphs explanatory of cases where the x-axes corresponding to the x-axis of the graph illustrated in FIG. 7 represent “1-minute temperature rise from 1 minute after the start of video shooting” and “1-minute temperature rise from 2 minutes after the start of video shooting”, respectively. The descending order in a deviation degree of plotted positions from the approximation straight line is FIG. 7>FIG. 12>FIG. 13. This is because there is variation in an amount of heat stored in members incorporated in the imaging device 100 immediately after the start of video shooting processing by the imaging device 100.

The present disclosure involves the fact that a correlative relationship appears between a rate of temperature rise of a heat generation source and the ambient temperature when an amount of heat of the CMOS image sensor 124 of the heat generation source is constant and a heat dissipation structure from the heat generation source to the housing 110 is constant. However, when there is variation in an amount of heat stored in members in a heat dissipation route, an error is caused in the correlative relationship between the rate of temperature rise of the heat generation source and the ambient temperature.

However, by acquiring the rate of temperature rise after the elapse of a predetermined period of time after a certain time has passed from the start of video shooting processing by the imaging device 100, heat capacity of the heat dissipation members is saturated during the certain time thereby increasing the correlative relationship between the rate of temperature rise of the heat generation source and the ambient temperature. On the other hand, when a period of time after the start of video shooting processing by the imaging device 100 until the temperature is acquired is too long, video shooting is terminated before the ambient temperature in practical use is updated. As a result, it is favorable that temperature rise during 1 minute from the time after 2 minutes from the start of video shooting is represented by the x-axis.

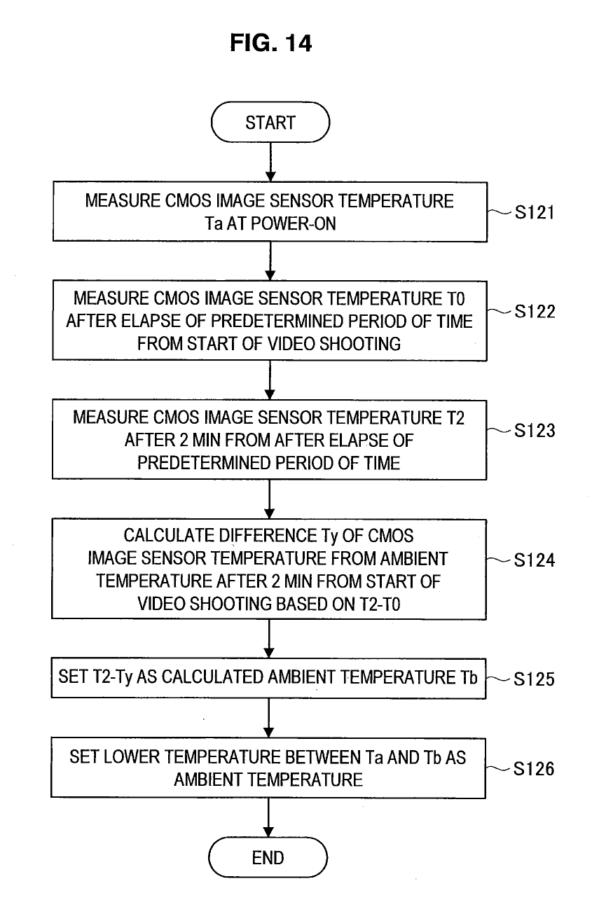

FIG. 14 is a flowchart illustrating a calculating method of the ambient temperature performed by use of the imaging device 100 according to the present embodiment. The calculating method of the ambient temperature performed by use of the imaging device 100 according to the present embodiment will be described in detail with reference to FIG. 14.

At first, the microprocessor 132 acquires a temperature Ta of the CMOS image sensor 124 by use of the temperature measuring part 140 when the imaging device 100 is powered on (step S121). The microprocessor 132 holds information of the acquired temperature Ta in the memory 134, for example. The temperature Ta can be considered as the ambient temperature around the imaging device 100 when the imaging device 100 is not used for a long time, for example, and the temperature Ta is appropriate for use as a temporary ambient temperature.

In the case where the temperature measuring part 140 acquires the temperature Ta of the CMOS image sensor 124 when the imaging device 100 is powered on, the microprocessor 132 waits thereafter until video shooting processing is started by a user of the imaging device 100. When the video shooting processing is started by the user of the imaging device 100, the microprocessor 132 acquires a temperature T0 of the CMOS image sensor 124 at the time after a predetermined period of time (e.g., 1 minute) from the start of video shooting processing by use of the temperature measuring part 140 (step S122).

Subsequently, the microprocessor 132 acquires a temperature T2 of the CMOS image sensor 124 by use of the temperature measuring part 140 after 2 minutes after the elapse of the predetermined period of time (e.g., 1 minute) from the start of video shooting processing (step S123). Note that, when the video shooting processing by use of the imaging device 100 is completed in less than 2 minutes, the microprocessor 132 may not measure the temperature T2.

Note that, though the ambient temperature is measured by acquiring the temperature T2 of the CMOS image sensor 124 after 2 minutes after the elapse of the predetermined period of time from the start of video shooting processing in the present embodiment by use of the temperature measuring part 140, the present disclosure is not limited to the example of this calculating method of the ambient temperature.

After completion of acquiring the temperatures T0 and T2, subsequently, the microprocessor 132 calculates T2−T0, and calculates the temperature difference Ty of the CMOS image sensor 124 from the ambient temperature after 2 minutes after the elapse of the predetermined period of time from the start of video shooting processing by substituting the calculated value into the linear function preliminarily stored in the memory 134 (step S124).

When the temperature difference Ty of the CMOS image sensor 124 from the ambient temperature after 2 minutes after the elapse of the predetermined period of time from the start of video shooting processing is calculated, subsequently, the microprocessor 132 sets a value obtained by an operation of subtraction of the temperature difference Ty from the temperature T2 as a calculated ambient temperature Tb (step S125). By calculating the ambient temperature as above, the variation in an amount of heat stored in the heat dissipation members can be inhibited and the ambient temperature can be more accurately calculated.

Next, monitoring processing of the temperature of the CMOS image sensor 124 performed by the imaging device 100 according to the embodiment of the present disclosure by using the ambient temperature calculated by the imaging device 100 as above will be described.

### 1-5. CMOS Image Sensor Temperature Monitoring Processing

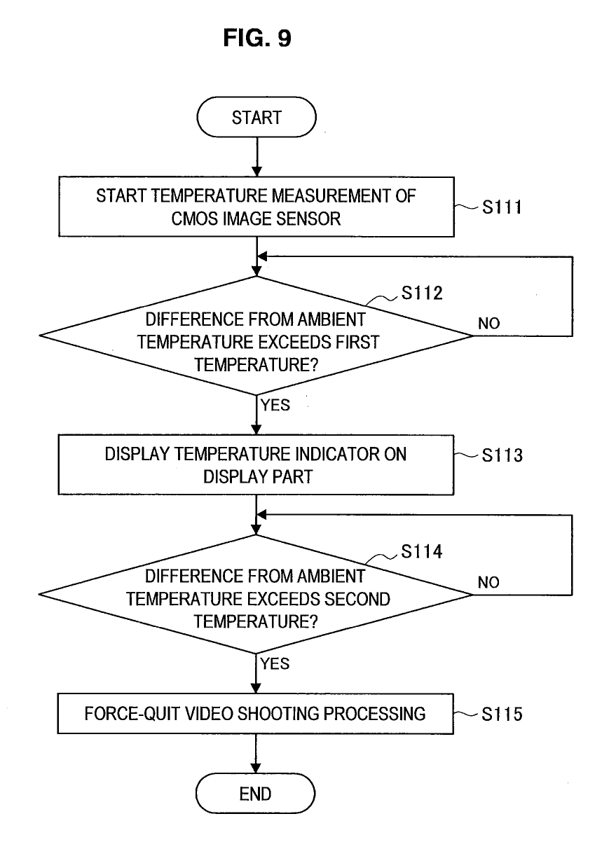

FIG. 9 is a flowchart illustrating monitoring processing of the temperature of the CMOS image sensor 124 according to an embodiment of the present disclosure. The monitoring processing of the temperature of the CMOS image sensor 124 will be described below with reference to FIG. 9. Note that, the monitoring processing of the temperature of the CMOS image sensor 124 illustrated in FIG. 9 is performed under the condition that the ambient temperature is calculated by the calculating method of the ambient temperature by use of the imaging device 100 illustrated in FIG. 8.

At first, the temperature measuring part 140 starts to measure a temperature of the CMOS image sensor 124 (step S111). Then, the microprocessor 132 monitors the temperature of the CMOS image sensor 124 measured by the temperature measuring part 140 and determines whether the ambient temperature calculated by the calculation method of the ambient temperature by use of the above-described imaging device 100 and the temperature of the CMOS image sensor 124 measured by the temperature measuring part 140 exceed a first predetermined temperature (e.g., 25° C.) (step S112).

When the temperature difference between the ambient temperature and the CMOS image sensor 124 does not exceed the first predetermined temperature, the microprocessor 132 continues monitoring the temperature of the CMOS image sensor 124 measured by the temperature measuring part 140. On the other hand, when the temperature difference between the ambient temperature and the CMOS image sensor 124 exceeds the first predetermined temperature, the microprocessor 132 issues a predetermined alert such as display processing of temperature information of the CMOS image sensor 124 on the display part 118 that the temperature of the CMOS image sensor 124 rises (step S113). Of course, the predetermined alert is not limited to the display processing of the temperature information of the CMOS image sensor 124 on the display part 118. For example, the predetermined alert may be a message that the temperature of the CMOS image sensor 124 rises displayed in a manner of overlapping a shot image on the display part 118.

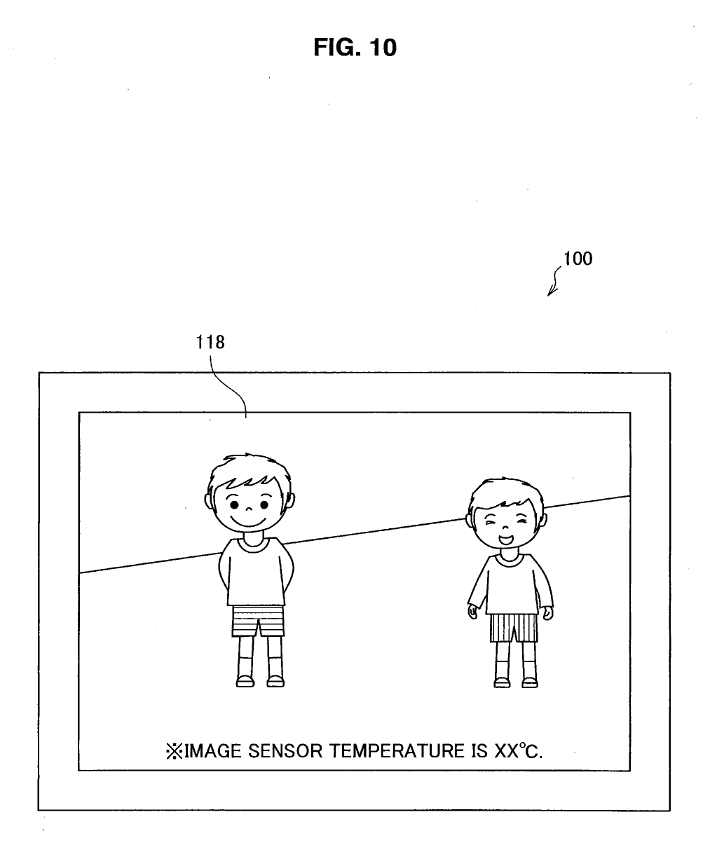

FIG. 10 is a diagram explanatory of an example of a temperature indicator displayed on the display part 118 displayed when the temperature difference between the ambient temperature and the CMOS image sensor 124 exceeds the first predetermined temperature. By displaying the temperature information of the CMOS image sensor 124 in the form of the temperature indicator by the microprocessor 132 as illustrated, a user of the imaging device 100 can be informed of the fact that the temperature of the CMOS image sensor 124 rises.

The microprocessor 132 determines whether the temperature difference between the ambient temperature and the CMOS image sensor 124 measured by the temperature measuring part 140 exceeds a second predetermined temperature (e.g., 30° C.) higher than the first predetermined temperature due to temperature rise of the CMOS image sensor 124 even after the temperature difference between the ambient temperature and the CMOS image sensor 124 exceeds the first predetermined temperature (step S114).

When the temperature difference between the ambient temperature and the CMOS image sensor 124 does not exceed the second predetermined temperature, the microprocessor 132 continues monitoring of the temperature of the CMOS image sensor 124 measured by the temperature measuring part 140. On the other hand, when the temperature difference between the ambient temperature and the CMOS image sensor 124 exceeds the second predetermined temperature, further temperature rise of the CMOS image sensor 124 causes noise increase that influences shot images and the user of the imaging device 100 is likely to suffer from low temperature burns due to temperature rise of the housing 110 to which heat of the CMOS image sensor 124 is transferred. Accordingly, the microprocessor 132 disconnects power distribution to the CMOS image sensor 124 and force-quits video shooting processing (step S115).

Note that, in the present disclosure, as processing after force-quitting of the video shooting processing in the case where the temperature difference between the ambient temperature and the CMOS image sensor 124 exceeds the second predetermined temperature, the microprocessor 132 may shift an operation mode of the imaging device 100 to another operation mode in which power consumption of the CMOS image sensor 124 is lower such as a live view display mode for display on the display part 118 because power consumption of the CMOS image sensor 124 in the live view display mode is lower in comparison with video shooting, or the microprocessor 132 may forcibly powered off the imaging device 100.

In the above description, the monitoring processing of the temperature of the CMOS image sensor 124 is described with reference to FIG. 9. As described above, noise generation on the shot images caused by temperature rise of the CMOS image sensor 124 can be reduced when the microprocessor 132 performs the monitoring processing of the temperature of the CMOS image sensor 124 and the user of the imaging device 100 can be prevented from discomfort feeling or low temperature burns by inhibiting temperature rise of the housing 110.

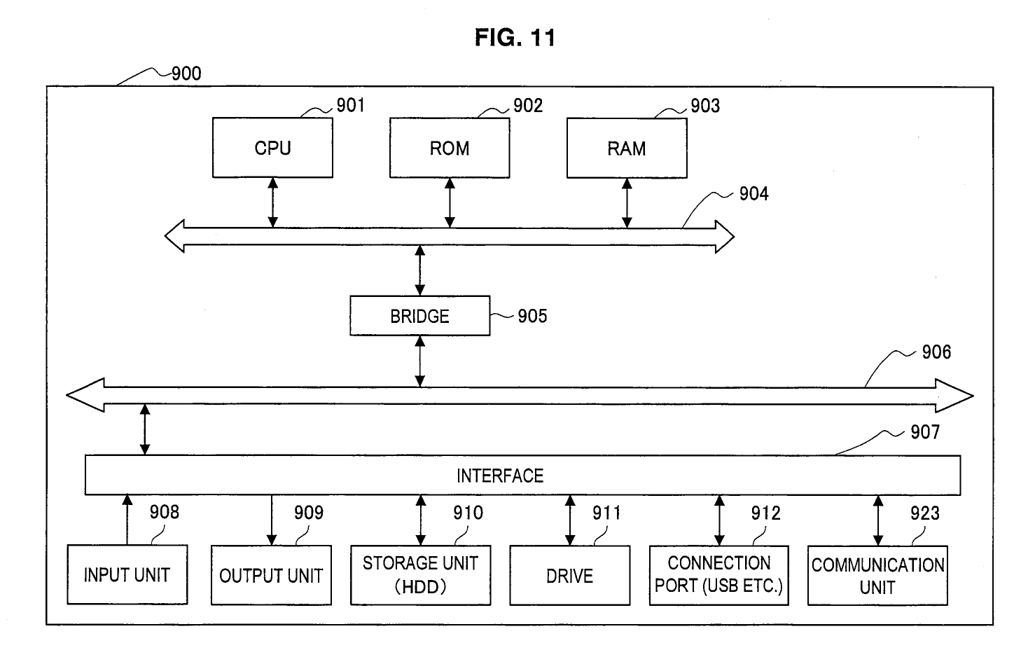

Note that, a series of processing described in the above-described embodiment may be performed by dedicated hardware and may be performed by software. When the series of processing is performed by software, the above-described series of processing can be achieved by causing a general-purpose or dedicated computer 900 illustrated in FIG. 11 to perform a program.

FIG. 11 is a diagram explanatory of a configuration example of the computer 900 achieving the series of processing by performing the program. The performance of the program for performing the series of processing by the computer 900 will be described below.

The computer 900 includes CPU (Central Processing Unit) 901, ROM (Read Only Memory) 902, RAM (Random Access Memory) 903, buses 904, 906, a bridge 905, an interface 907, an input unit 908, an output unit 909, a storage unit 910 such as HDD and others, a drive 911, a connection port 912 such as USB and others and a communication unit 913 as illustrated in FIG. 11, for example. Those components are connected in a manner to transmit information with one another via the buses 904 and 906 connected by the bridge 905, via the interface 907, or the like.

The program can be recorded in the storage unit 910 such as HDD (Hard Disk Drive) or SSD (Solid State Drive), ROM 902, RAM 903 and the like that are examples of a recording unit.

Alternatively, the program can be temporarily or permanently recorded in a removable storage medium (not shown) including a magnetic disk such as a flexible disk, an optical disk such as various types of CD (Compact Disc), MO (Magneto Optical) disk or DVD (Digital Versatile Disc), or a semiconductor memory. Such removable storage medium may be supplied as a so-called software package. The program recorded in such removable storage medium may be read by the drive 911 and recorded in the above-described recording unit via the interface 907, the buses 904, 906 or the like.

Further, the program may be recorded on a download site, another computer, another recording unit (not shown) or the like. In this case, the program is transferred over a network (not shown) such as LAN (Local Area Network) or the Internet, and the communication unit 913 receives the program. Alternatively, the program may be transferred from another recording unit or another communication unit connected to the connection port 912 such as USB (Universal Serial Bus). Further, the program received by the communication unit 913 or the connection port 912 may be recorded in the above-described recording units via the interface 907, the buses 904, 906 or the like.

When CPU 901 performs various kinds of processing in accordance with the program recorded in the above-described recording unit, the above-described series of processing is achieved. In this case, CPU 901 may directly read the program from the above-described recording unit, or may perform after the program is once loaded on RAM 903. Further, when the program is received via the communication unit 913 or the drive 911, for example, CPU 901 may directly perform the received program without recording in the recording unit.

Still further, CPU 901 may perform the various kinds of processing based on signals and information input from the input unit 908 such as a mouse, a keyboard or a microphone (those are not shown), or from another input unit connected to the connection port 912 as necessary.

Still further, CPU 901 may output results of performing the above-described series of processing from the display unit such as a monitor or from the output unit 909 including a sound output unit such as a speaker or head phones. Still further, CPU 901 may transmit the result of the processing from the communication unit 913 or the connection port 912, or may record the result of the processing in the above-described recording unit or the removable recording medium as necessary.

Note that, in the present specification, steps described in the flowchart may be performed in chronological order along the description order, of course, but not limited to. The steps may be performed in parallel or separately.

### 2. CONCLUSION

As described above, according to the embodiment of the present disclosure, when the CMOS image sensor 124 continues to consume constant power as in the case of video shooting processing, the temperature difference of the CMOS image sensor 124 from the ambient temperature can be calculated by substituting the temperature rise degree of the CMOS image sensor 124 during a predetermined period of time to the relational formula, preliminarily held in the memory 134, between the temperature rise x of the CMOS image sensor 124 and the temperature difference y of the CMOS image sensor 124 from the ambient temperature after the elapse of the predetermined time from the start of constant power consumption by the CMOS image sensor 124. Subsequently, the ambient temperature can be calculated by subtracting, from the temperature of the CMOS image sensor 124, the temperature difference of the CMOS image sensor 124 from the ambient temperature. At this time, by assuming that the temperature rise x of the CMOS image sensor 124 is the temperature rise further after the elapse of a predetermined period of time from the starting time point after the elapse of the predetermined time from the start of the certain power consumption, variation in the amount of heat stored in the heat dissipation members can be inhibited and the ambient temperature can be more accurately calculated.

By displaying temperature information on the display part 118 when the temperature difference of the CMOS image sensor 124 from the ambient temperature calculated as above exceeds the predetermined value, the imaging device 100 can alert the user of the imaging device 100 that the temperature of the CMOS image sensor 124 rises. When the temperature difference further increases, the imaging device 100 can reduce noise generation on the shot images or prevent the user of the imaging device 100 from low temperature burns, which are caused by temperature rise of the CMOS image sensor 124, by reducing or stopping power supply to the CMOS image sensor 124.

Note that, the imaging device 100 is described as an example of the electronic device of the present disclosure in the above-described embodiment, but it is obvious that the present disclosure is not limited to the above example. The present disclosure is applicable to electronic devices in general in which a component (e.g., CPU) generating heat by the power supply is placed.

In the above description, a preferred embodiment of the present disclosure is described in detail with reference to the appended figures, but the present disclosure is not limited to the above-described embodiment. It should be understood by those skilled in the art that various modifications, combinations, sub-combinations and alterations may occur depending on design requirements and other factors insofar as they are within the scope of the appended claims or the equivalents thereof.

For example, the above-described first predetermined temperature and second predetermined temperature may vary in accordance with the ambient temperature calculated by the calculating method of the ambient temperature by using the imaging device 100 illustrated in FIG. 8. It is because the temperature of the housing 110 that the user of the imaging device 100 feels hot when holding the imaging device 100 also depends of the ambient temperature. Accordingly, the more flexible monitoring processing on the temperature of the CMOS image sensor 124 can be achieved by varying the first predetermined temperature and the second predetermined temperature in accordance with the ambient temperature.

Further, in the above-described embodiment, the imaging device 100 has a structure such that the temperature measuring part 140 is placed on the drive substrate 125 for driving the CMOS image sensor 124 to measure the temperature of the CMOS image sensor 124, but the present disclosure is not limited to the above example. For example, such a structure may be applicable in which a temperature sensor capable of measuring the temperature of the CMOS image sensor 124 is included at the time of manufacturing the CMOS image sensor 124 and the temperature sensor measures the temperature of the CMOS image sensor 124.

Still further, in the heat dissipation structure of the imaging device 100 according to the embodiment of the present disclosure illustrated in FIG. 4, in the case where a substrate (e.g., flexible substrate) can be placed so as to touch the portion such as the heat sink 142 or protrusions 111a, 111b to which heat of the CMOS image sensor 124 is transferred, the temperature sensor may be placed on the substrate. By proving the temperature sensor on such position, temperature variation of the CMOS image sensor 124 can be detected and the ambient temperature can be calculated.

Additionally, the present technology may also be configured as below.

(1) An electronic device comprising:

a temperature measuring part measuring a temperature of a heat generation source generating heat caused by power consumption or of a portion inside a housing that varies in temperature due to heat generation of the heat generation source; and

an ambient temperature calculating part calculating a temperature by use of a predetermined relational formula that differs according to a model based on a difference between a first temperature measured by the temperature measuring part after the elapse of a first predetermined period of time from the start of constant power consumption by the heat generation source and a second temperature measured by the temperature measuring part further after the elapse of a second predetermined period of time from the time point after the elapse of the first predetermined period of time from the start of the constant amount of power consumption by the heat generation source as an ambient temperature of an environment in which the housing is placed.

(2) The electronic device according to (1), wherein the first predetermined period of time is determined in consideration of a condition of a heat dissipation route through which heat from the heat generation source is transferred to the housing.
(3) The electronic device according to (2), wherein the first predetermined period of time is determined in consideration of a period of time until heat capacity of the heat dissipation route through which heat from the heat generation source is transferred to the housing is saturated.
(4) The electronic device according to (2), wherein the first predetermined period of time is determined in consideration of a period of time until heat stored in the heat dissipation route before the heat generation source starts to consume constant power does not exert influence on calculation of the ambient temperature by the ambient temperature calculating part.
(5) The electronic device according to (2), wherein the first predetermined period of time is determined in consideration of a period of time until heat conduction from the heat generation source to the heat dissipation route that transfers heat to the housing and heat conduction from the heat dissipation route to the housing reach the same level.
(6) The electronic device according to any one of (1) to (5), wherein the ambient temperature calculating part holds a third temperature measured by the temperature measuring part at the time of power-on and calculates a lower temperature selected between the third temperature and a temperature calculated by using the predetermined relational formula calculated based on a difference between the first temperature and the second temperature as the ambient temperature.
(7) The electronic device according to any one of (1) to (6), further comprising an operation control part outputting an alert when a difference between the ambient temperature calculated by the ambient temperature calculating part and the temperature measured by the temperature measuring part exceeds a first predetermined value.
(8) The electronic device according to (7), wherein the operation control part causes power supply to the heat generation source to be stopped when the difference between the ambient temperature calculated by the ambient temperature calculating part and the temperature measured by the temperature measuring part exceeds a second predetermined value larger than the first predetermined value.
(9) The electronic device according to any one of (1) to (8), wherein the temperature measuring part is directly placed on the heat generation source.
(10) The electronic device according to any one of (1) to (9), wherein the temperature measuring part is placed on a substrate placed in contact with the heat generation source for driving the heat generation source.
(11) The electronic device according to any one of (1) to (10), wherein the heat generation source is an image sensor.
(12) An electronic device control method comprising:

measuring a first temperature of a heat generation source generating heat caused by power consumption or of a portion inside a housing that varies in temperature due to heat generation of the heat generation source after the elapse of a first predetermined period of time from the start of constant power consumption by the heat generation source;

measuring a second temperature of the heat generation source or of the portion inside the housing further after the elapse of a second predetermined period of time from the time point after the elapse of the first predetermined period of time from the start of the constant amount of power consumption by the heat generation source; and

calculating a temperature by use of a predetermined relational formula that differs according to a model based on a difference between the first temperature measured in the first temperature measuring step and the second temperature measured in the second temperature measuring step as an ambient temperature of an environment in which the housing is placed.

(13) The electronic device control method according to (12), further comprising measuring a third temperature of the heat generation source or of the portion inside the housing at the time of power-on of the electronic device; and

calculating a lower temperature selected between the third temperature and the temperature calculated by using the predetermined relational formula calculated based on the difference between the first temperature and the second temperature as the ambient temperature.

(14) The electronic device control method according to (12) or (13), further comprising outputting an alert when a difference between the ambient temperature calculated in the ambient temperature calculation step and the temperature of the heat generation source or of the portion inside the housing exceeds a first predetermined value.
(15) The electronic device control method according to (14), further comprising causing power supply to the heat generation source to be stopped when the difference between the ambient temperature calculated in the ambient temperature calculation step and the temperature of the heat generation source or of the portion inside the housing exceeds a second predetermined value larger than the first predetermined value.

The present disclosure contains subject matter related to that disclosed in Japanese Priority Patent Application JP 2011-177053 filed in the Japan Patent Office on Aug. 12, 2011, the entire content of which is hereby incorporated by reference.

What is claimed is:

1. An electronic device comprising:
a temperature measuring part measuring a temperature of a heat generation source generating heat caused by power consumption or of a portion inside a housing that varies in temperature due to heat generation of the heat generation source; and
an ambient temperature calculating part calculating a temperature by use of a predetermined relational formula that differs according to a model based on a difference between a first temperature measured by the temperature measuring part after the elapse of a first predetermined period of time from the start of constant power consumption by the heat generation source and a second temperature measured by the temperature measuring part further after the elapse of a second predetermined period of time from the time point after the elapse of the first predetermined period of time from the start of the constant amount of power consumption by the heat generation source as an ambient temperature of an environment in which the housing is placed.

2. The electronic device according to claim 1, wherein the first predetermined period of time is determined in consideration of a condition of a heat dissipation route through which heat from the heat generation source is transferred to the housing.

3. The electronic device according to claim 2, wherein the first predetermined period of time is determined in consideration of a period of time until heat capacity of the heat dissipation route through which heat from the heat generation source is transferred to the housing is saturated.

4. The electronic device according to claim 2, wherein the first predetermined period of time is determined in consideration of a period of time until heat stored in the heat dissipation route before the heat generation source starts to consume constant power does not exert influence on calculation of the ambient temperature by the ambient temperature calculating part.

5. The electronic device according to claim 2, wherein the first predetermined period of time is determined in consideration of a period of time until heat conduction from the heat generation source to the heat dissipation route that transfers heat to the housing and heat conduction from the heat dissipation route to the housing reach the same level.

6. The electronic device according to claim 1, wherein the ambient temperature calculating part holds a third temperature measured by the temperature measuring part at the time of power-on and calculates a lower temperature selected between the third temperature and a temperature calculated by using the predetermined relational formula calculated based on a difference between the first temperature and the second temperature as the ambient temperature.

7. The electronic device according to claim 1, further comprising an operation control part outputting an alert when a difference between the ambient temperature calculated by the ambient temperature calculating part and the temperature measured by the temperature measuring part exceeds a first predetermined value.

8. The electronic device according to claim 7, wherein the operation control part causes power supply to the heat generation source to be stopped when the difference between the ambient temperature calculated by the ambient temperature calculating part and the temperature measured by the temperature measuring part exceeds a second predetermined value larger than the first predetermined value.

9. The electronic device according to claim 1, wherein the temperature measuring part is directly placed on the heat generation source.

10. The electronic device according to claim 1, wherein the temperature measuring part is placed on a substrate placed in contact with the heat generation source for driving the heat generation source.

11. The electronic device according to claim 1, wherein the heat generation source is an image sensor.

12. An electronic device control method comprising:
measuring a first temperature of a heat generation source generating heat caused by power consumption or of a portion inside a housing that varies in temperature due to heat generation of the heat generation source after the elapse of a first predetermined period of time from the start of constant power consumption by the heat generation source;
measuring a second temperature of the heat generation source or of the portion inside the housing further after the elapse of a second predetermined period of time from the time point after the elapse of the first predetermined period of time from the start of the constant amount of power consumption by the heat generation source; and
calculating a temperature by use of a predetermined relational formula that differs according to a model based on a difference between the first temperature measured in the first temperature measuring step and the second temperature measured in the second temperature measuring step as an ambient temperature of an environment in which the housing is placed.

13. The electronic device control method according to claim 12, further comprising measuring a third temperature of the heat generation source or of the portion inside the housing at the time of power-on of the electronic device; and
calculating a lower temperature selected between the third temperature and the temperature calculated by using the predetermined relational formula calculated based on the difference between the first temperature and the second temperature as the ambient temperature.

14. The electronic device control method according to claim 12, further comprising outputting an alert when a difference between the ambient temperature calculated in the ambient temperature calculation step and the temperature of the heat generation source or of the portion inside the housing exceeds a first predetermined value.

15. The electronic device control method according to claim 14, further comprising causing power supply to the heat generation source to be stopped when the difference between the ambient temperature calculated in the ambient temperature calculation step and the temperature of the heat generation source or of the portion inside the housing exceeds a second predetermined value larger than the first predetermined value.
